(19) United States
(12) Patent Application Publication
(10) Pub. No.: US 2005/0163109 A1
(43) Pub. Date: Jul. 28, 2005

(54) Communication arrangement for automatically accepting and switching an incoming communication connection

(75) Inventor: Ulrich Schmitz, Wurselen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/044,132

(22) Filed: Jan. 27, 2005

(30) Foreign Application Priority Data
Jan. 28, 2004 (DE) 102004004276.4 DE

(51) Int. Cl. H04L 12/66

(52) U.S. Cl. 370/352

(57) ABSTRACT

The invention relates to a communication arrangement for automatically switching an incoming communication connection (b). To this end, a switching center (VE2) for forwarding the communication connection (b) to a switching destination (AG1) is provided. A first processing unit (IV2) is used for interactively requesting, storing and evaluating basic information from a caller, the first processing unit (IV2) being designed to interact with a memory (SP2) in which the switching destination (AG1) can be selected using the basic information and from which it is possible to retrieve address information about the selected switching destination (AG1). In this case, the first processing unit (IV2) is set up to transmit the address information to the switching center (VE2) for forwarding and to transfer the communication connection (b) to a waiting device (W2). The waiting device (W2) is designed to hold the forwarded communication connection, with holding being continued until the forwarded and communication connection is accepted by the switching destination. The waiting device (W2) is equipped with a second processing unit (IV3) for interactively requesting, storing and evaluating further information.

### CROSS REFERENCE TO RELATED APPLICATIONS

This application is the US National Stage of German application No. 102004004276.4 DE filed Jan. 28, 2004 and which is incorporated by reference herein in its entirety.

### FIELD OF INVENTION

The invention relates to a communication arrangement for automatically accepting and switching an incoming communication connection and to a method for operating a processing unit for interactively requesting, storing and evaluating information from a caller.

### BACKGROUND OF INVENTION

For telephone enquiries from customers and other callers, authorities, banks, insurance companies and other companies frequently provide central telephone numbers which are used by the caller not to call a particular department or a particular employee directly, but rather to allow a whole group of switching destinations to be reached. Such central telephone numbers are frequently also referred to as “hotlines”. In this case, the calls on such central telephone numbers are distributed—usually fully automatically—within a group of employees, the “agents”. In this context, an arrangement of this type is frequently also referred to as a “call center” and a corresponding device for call distribution is referred to as ACD (Automatic Call Deflection).

Frequently, the call distribution device is part of a private branch exchange (switching center) which distributes the incoming communication connections (calls) over the available agents according to a defined algorithm. In this case, it is possible for the respective next incoming call, for example, to be routed to that agent that is currently free and that has had the longest waiting phase among all of the free agents to date.

However, simple call distribution of this type allows no account to be taken of any specialization by the agents, i.e. the allocation of the respective caller to the respective agent reached is of a random nature and, if the agents have specialized, it is highly probable that the caller will first need to be forwarded from a first agent (that is not competent to deal with the request) to a further, competent agent (switching destination) before the call is answered and handled with any qualification.

Call distribution devices are also known which evaluate the telephone number information (“clip”) from the caller and then forward the call (e.g. by evaluating the dialing code number) to that agent that is associated with a corresponding range of dialing code numbers. Alternatively, the transmitted telephone number information may also be compared with entries in a database in order to identify the caller as a customer, for example, from the telephone number information when there is a match and hence to connect this caller to the appropriate operative.

Since the telephone number information (which in many cases is not actually transmitted in the first place) from incoming communication connections frequently does not provide sufficient information content for satisfactory forwarding, one alternative to switching using a natural person which is increasingly being used is processing units which use a computer-controlled interactive dialogue to request the information required for forward from the caller. Such processing units, which are regularly not part of a switching center itself, are frequently also referred to as IVR (“Interactive Voice Response”) systems.

In the IVR systems, the caller is typically asked questions by a synthetically generated voice or by audio recordings played back, and the caller answers these questions either by pressing a key on his communication terminal (DTMF dialing) or by speaking keywords “yes”, “no”, “one”, “two”, “three”). These responses are evaluated by an appropriate recognition device (DTMF tone recognition or voice analysis methods), are combined into one data record and are transmitted to a call distribution device.

This call distribution device, which is frequently also referred to as “routing engine” or else as a “call center routing engine” in this context, is essentially equipped with a memory which stores the agents from a call center with their internal telephone numbers (address information) and their “characteristics” (for example areas of responsibility, specialist fields etc.). In this case, the information transmitted with the data record is used to search the memory for the appropriate agent (that is to say the switching destination) or for a group of suitable agents. In the meantime, the communication connection, in which the caller is waiting to be connected to the switching destination, is put back into the switching center by the IVR system and is held in a “waiting field” in the switching center, i.e. the caller is connected to a “virtual port” in the switching center and hears a ringing tone or the caller is played a piece of “waiting music”. During this waiting time, the switching center sets up a communication connection to the switching destination and switches the waiting communication connection to the called agent's communication terminal as soon as the call is signaled on this communication terminal (the communication terminal “rings”). The caller now hears a ringing tone until the agent accepts the call.

The known arrangements for automatically accepting and switching communication connections have been found to have the drawback that they have little functionality.

### SUMMARY OF INVENTION

It is therefore an object of the present invention to extend the functionality of communication arrangements with automatic acceptance and switching.

The object is achieved for the communication arrangement, the communication server and the method by the features of the claims.

The object for the communication arrangement is achieved by virtue of an incoming communication connection being automatically accepted and switched using a switching center for forwarding the communication connection to a switching destination. In this case, a first processing unit is used for interactively requesting, storing and evaluating basic information from a caller, the first processing unit being designed to interact with a memory in which the switching destination can be selected using the basic information and from which it is possible to retrieve address information about the selected switching destination. The first processing unit is set up to transmit the address information to the switching center for forwarding the communication connection and to transfer the communication connection to a waiting device, where the waiting device is designed to hold the forwarded communication connection, and holding continues until the forwarded communication connection is accepted. In this case, the waiting device is equipped with a second processing unit for interactively requesting, storing and evaluating further information. As a result, information can be interactively requested from a caller even in the period in which his communication connection is being held in the waiting device. Furthermore, a communication arrangement of this type can be operated using a switching center of low-cost design which does not require its own waiting device.

A further advantage is provided by virtue of it being possible to dispense with the return of the connection from the IVR system to the switching center. In this case, the IVR system does not need to match the control of a waiting field (waiting device) in the switching center used. If the connection which has been switched is not accepted by the selected agent, then the call also no longer needs to be put back into the IVR system as “undeliverable” for fresh switching, which means that a complex and hence error-prone procedure is avoided for the communication system.

The object is achieved for the communication server by designing a processing unit to interact with a memory for the purpose of interactively requesting, storing and evaluating basic information from a caller. The switching destination can be selected from this memory using the basic information, and address information about the selected switching destination can be retrieved from it, the processing unit being set up to transmit the address information to the switching center for forwarding the communication connection and to transfer the communication connection to a waiting device. In this case, the waiting device is designed to hold the forwarded communication connection, with holding being continued until the forwarded communication connection is accepted, and with the waiting device being equipped with a second processing unit for interactively requesting, storing and evaluating further information. A communication server of this type which advantageously integrates the waiting device and the second processing unit allows simple switching centers without their own waiting field to be provided with a powerful and convenient function for call acceptance and forwarding. In this case, the function of the second processing unit may also be performed by a first stage in the processing unit, which means that internal forwarding of the communication connection within the processing unit is avoided.

The communication arrangement, the communication server, and the method are advantageously refined further by the features of the claims.

If the waiting device with the second processing unit is formed by a stage in the first processing unit, it is possible to save forwarding the communication connection between the first and second processing units. The first processing unit then remains the terminating point of the communication connection during the entire interactive requesting, storage and/or evaluation of the information. In addition, the call can also be forwarded to an alternative switching destination if the selected switching destination is unavailable in this case.

If the second processing unit is designed to interact with the memory, in which an alternative switching destination can be selected using the basic information and the further information and from which it is possible to retrieve further address information about the alternative switching destination, with the second processing unit being set up to transmit the address information to the switching center for forwarding the communication connection to the alternative switching destination, then the selection of the switching destination can be corrected and optimized until the first switching destination selected accepts the communication connection. In this case, it is firstly possible for the communication connection actually to be forwarded at a very early time, but is secondly also possible for the further information obtained later to be nevertheless used for selecting the switching destination.

The object is achieved for the method by performing a plurality of method steps in order to operate a processing unit for interactively requesting, storing and evaluating information from a caller. First, a communication connection from a caller is switched to the processing unit by a switching center. Next, the processing unit requests basic information from the caller in a first interactive process, after which the processing unit accesses a memory in order to ascertain address information for a switching destination for the caller using the basic information. The processing unit then requests further information from the caller in a second interactive process, while the processing unit sends the address information to the switching center and hence initiates the transfer of the communication connection to the ascertained switching destination, with a communication terminal at the switching destination signaling the communication connection for transfer by ringing. Finally, the call is accepted on a communication terminal at the switching destination, as a result of which the communication is transferred to this communication terminal. At the same time, the second interactive process for requesting the further information is terminated in the processing unit. By performing these method steps, the audio signal (voice data stream) or the (keypad) inputs by the caller is/are analyzed for the whole time in which the processing unit forms the terminal point of the communication connection. In addition, the inventive method also allows the use of switching centers which do not have their own “waiting field” for communication connections which are to be held. The fact that the switching center does not have to hold the communication connection itself, but rather the communication connection is merely forwarded to the processing unit in a first step and is forwarded to the (final end) switching destination in a further step, significantly relieves the load on the switching center and thus allows it to be of more economical design. There is no need for any particular match between the processing unit and the switching center in this case.

### BRIEF DESCRIPTION OF THE DRAWINGS

Exemplary embodiments to explain the inventive communication arrangement are explained below with reference to the drawings and are simultaneously used to explain an exemplary embodiment of the inventive method.

In the drawings:

FIG. 1 shows an inventive communication arrangement with a switching center, a processing unit with a waiting device, a memory and a switching destination, and

FIG. 2 shows the prior art with a switching center with an (integrated) waiting device, a processing unit, a memory and a switching destination.

### DETAILED DESCRIPTION OF INVENTION

FIG. 2 shows a communication arrangement for automatically accepting and switching an incoming communication connection a based on the prior art. In the figure, a communication terminal AN associated with a caller is connected to a communication node KN1 via a public communication network PSTN. In a private communication network (not shown here), the communication node KN1, a communication server KS1, a call distribution device ACD1 and communication terminals AG1, AG2, AGN are connected, the latter communication terminals AG1, AG2, AGN being associated with various “agents” (employees) in a company (call center) and being able to be selected as switching destinations.

The figures visually display communication connections in the form of arrows, with one and the same communication connection being able to have various terminal points in the private communication network in succession as a result of changeover or forwarding. Data connections (d1, d2, e1, e2) are shown as double-headed arrows in the figures.

The communication connections shown in the figures may be either circuit-switched communication connections or communication channels in a voice data network (VoIP network; VoIP=Voice over Internet Protocol). In the latter case, the communication node KN1, for example, is not in the form of a circuit-switching telephone system, but rather is in the form of a control device (e.g. a gatekeeper or SIP proxy server) in a voice data network; the associated communication terminals are also referred to as “clients” in this context.

The text below makes reference to FIG. 2 to explain how a communication connection in the communication arrangement shown is forwarded in the prior art. The communication terminal AN associated with the caller is connected to the communication node KN1 via the public communication network PSTN by means of the communication connection a and is connected by a switching center VE at the communication node KN1, using the communication connection element a1, to the communication server KS1, where it is accepted by a processing unit IV1 in the communication server KS1. The processing unit IV1 is an interactive processing unit which uses the communication connection a, a1 to request basic information from the caller. In this example, the caller is in this case first of all asked to select from a list of departments to which he could be connected (sales, purchasing, customer service), with the customer being able to press an associated tone dialing key (DTMF key) on his communication terminal AN1 for each of the departments. When the department has been selected, the processing unit IV1 also asks the customer for the zip code for his location in a subsequent step, and the details learnt (department, zip code) are then combined into one data record and are sent from the processing unit IV1 to the call distribution device ACD1 via the data connection d1.

In addition, the processing unit IV1 terminates the communication connection element a1 and transfers an instruction to the switching center VE when the communication connection element a1 is cleared down, according to which instruction the communication connection a is connected to a waiting device W1 (“waiting field”) at the communication node KN1 by the switching center VE via the (internal) communication connection element a2. The caller then hears a waiting melody or an audio file containing music and speech. In the case of “multimedia clients”, it is naturally also possible to use video clips or the like as “waiting information”.

Using the basic information transmitted with the data record, the call distribution device ACD1 selects from its memory SP1 an employee (agent) who is suitable for accepting the call and in so doing retrieves the internal telephone number of the communication terminal AG1 (selected here) from the memory SP1 as address information. This telephone number is transmitted from the call distribution device ACD1 to the switching center VE via the data connection d2 together with the information that the transmitted telephone number is intended to be the switching destination for the waiting communication connection a, a2. The switching center VE then sets up a communication connection element a3 to the communication terminal AG1, with call signaling (“ringing”) then taking place on the communication terminal AG1 and with the switching center VE connecting the communication connection a to the communication connection element a3. The caller now hears a ringing tone on his communication terminal AN. As soon as the selected employee accepts the call on his communication terminal AG1, a two-way voice connection via the communication connection a, a3 is set up between the communication terminals AN and AG1, which means that the incoming communication connection a has now been finally switched to the switching destination (communication terminal AG1).

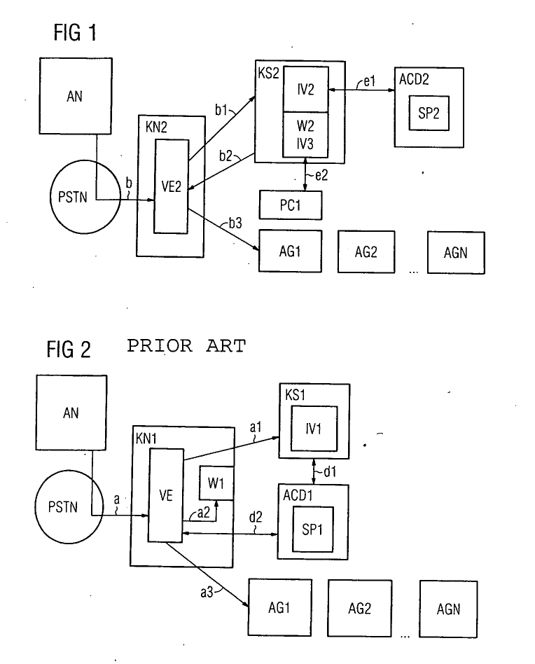

The text below makes reference to FIG. 1 to describe the acceptance and switching of a communication connection b using a communication arrangement based on the invention. Where components and devices have been denoted by the same reference symbols as in the description for FIG. 2, these are respectively components which are the same or have the same function.

The caller's communication terminal AN uses the public communication network PSTN to set up a communication connection b to the communication node KN2, where the communication connection b is forwarded to the processing unit IV2 (first processing unit) of a communication server KS2 via the communication connection element b1. The processing unit IV2 is also an interactive processing unit (interactive voice response) which is again used to request basic information (name of the desired department, zip code of the caller or the like) from the caller in this case too. The basic information obtained is again combined into one data record and is transmitted to the call distribution device ACD2 with the memory SP2 via the data connection e1. The communication connection b, b1 is then processed further by the communication server KS2, but this time by the waiting device W2, which is combined with the processing unit IV3 (second processing unit) and in the present exemplary embodiment is formed by the same application software as also forms the processing unit IV2. The change by the communication connection b1 from the processing unit IV2 to the waiting device W2 with the processing unit IV3 takes place unnoticed by the caller in this case.

The processing unit IV3 subsequently asks the caller for further information, in this case the caller's customer number, for example. This customer number is spoken by the caller following a request in plain text and is translated into a numeric form by a voice analysis unit in the processing device IV3 and is added to the data record. The call distribution device ACD2 uses the basic information transmitted via the data connection e1 to search the association tables stored in the memory SP2 for a suitable employee to accept the call, and in this case too it is the employee with the communication terminal AG1, which additionally has an associated personal computer PC1. The telephone number of the communication terminal AG1 which (telephone number) is obtained in this manner (in a VoIP voice data network this would accordingly be the IP address of a communication client AG1) is then sent as address information to the communication server KS2 via the data connection e1.

The communication server KS2 then sets up a communication connection element b2 to the switching center VE in order to set up a call to the communication terminal AG1 as a result. The switching center VE then uses a communication connection element b3 to signal a call on the communication terminal AG1 until this call is accepted on the communication terminal AG1. When the call is accepted, the communication server KS2 initiates transfer of the communication connection element b1 to the communication connection element b2 by the switching center VE. Said communication connection element b2 is, of course, already connected to the communication terminal AG1 via the communication connection element b3. Such transfer of a communication connection is a standard procedure for switching centers which then results in the communication connection b being connected up to the communication connection element b3 and in the communication connection elements b1, b2, which are now no longer required, being cleared down. During the transfer, the processing device IV3 uses the data connection e2 to send a customer data record containing the basic information and containing the further information to the personal computer PC1, so that the employee with the communication terminal AG1 has the hitherto collected information about the caller available on his personal computer PC1. In this case, the information received may be used to open a customer database, for example, which means that the employee immediately has available all of the information about the caller (e.g. customer) which is already present in the customer database.

In one particular embodiment of the communication arrangement, up to the time at which the call is accepted on the communication terminal AG1, it is possible for the further information collected by the processor unit UV3 to be repeatedly transmitted to the call distribution device ACD2 together with the basic information. If, as a result of the further information, an employee other than the one first selected is then filtered out of the memory SP2, the address information (internal telephone number) for this different employee is then transmitted to the communication server KS2, after which the call setup to the communication terminal AG1 via the communication connection element b2 is stopped and fresh call setup is initiated instead, this time to the communication terminal associated with the other, more suitable employee.

Instead of separate processing units (first processing unit IV2, second processing unit IV3), it is also possible to use a single processing unit, this unit then operating in two stages by distinguishing between two operating states. In this case, the first operating state applies until sufficient (basic) information has been recorded for (at least first, provisional) switching. The processing unit then changes over to the second operating state, in which the switching operation to (the at least provisional) switching destination takes place in parallel with the detection of the further information “in the background”. This switching destination can, as already mentioned, also be changed again during this phase, for example on account of the further information or on account of the selected switching destination not being reached.

The use of a single, for example two-stage, processing unit avoids a change from one to another processing unit which is noticeable to the caller; in addition, the programming complexity for a single, if also multistage, processing unit is lower, because it is possible to avoid multiple reservation of a large number of functional modules. Furthermore, a “combined” processing unit of this type has fewer interfaces in total than the separate architecture, which increases the reliability of an arrangement of this type.

The VoIP networks are often used not just for transmitting speech but also other communication services are used, for example video or text (e.g. “chatting”). These communication services may also be interactively incorporated into the switching of communication connections, which means that a video clip is shown as waiting information while a video telephone call is being switched, for example, or graphical selection menus are used when requesting information.

1.-8. (canceled)

9. A communication arrangement for automatically accepting and switching an incoming communication connection, comprising:
a switching center for forwarding the communication connection to a switching destination;
a first processing unit for interactively requesting, storing and evaluating caller information, the first processing unit adapted to transmit an address information to the switching center for forwarding the communication connection and to transfer the communication connection;
a memory interacting with the first processing unit, the switching destination is selected from the memory using the caller information so that the address information about the selected switching destination can be retrieved; and
a waiting device receiving the transferred communication connection, the waiting device designed to hold the forwarded communication connection until the forwarded communication connection is accepted, the waiting device equipped with a second processing unit for interactively requesting, storing and evaluating further information.

10. The communication arrangement as claimed in claim 9, wherein the waiting device is formed by a stage in the first processing unit.

11. The communication arrangement as claimed in claim 9, wherein:
the second processing unit interacts with the memory,
an alternative switching destination selected from the memory by using the caller information and the further information,
a further address information about the alternative switching destination is retrieved from the memory,
the second processing unit for transmitting the further address information to the switching center, and
the switching center for forwarding the communication connection to the alternative switching destination.

12. The communication arrangement as claimed in claim 9, wherein:
the second processing unit interacts with the memory,
an alternative switching destination is selected from the memory by using the caller information and the further information,
a further address information about the alternative switching destination is retrieved from the memory,
the second processing unit for transmitting the address information to the switching center, and
the switching center for forwarding the communication connection to the alternative switching destination.

13. A communication server, comprising:
a first processing unit for interactively requesting, storing and evaluating caller information;
an address information retrieved from a memory which is accessible from the first processing unit, the address information based on a switching destination selectable from the memory by using the caller information;
a waiting device designed to hold a forward communication connection until the forwarded communication is accepted; and
a second processing unit for interactively requesting, sorting and evaluating further information associated with the waiting device,
wherein the processing unit transmits the address information to a switching center for forwarding the communication connection and to transfer the communication to the waiting device.

14. The communication server as claimed in claim 13, wherein the waiting device is formed by a stage in the first processing unit.

15. A method for operating a processing unit for interactively requesting, storing and evaluating caller information, comprising:
accepting a caller communication connection by the processing unit;
requesting caller information by the processing unit from a caller in a first interactive process;
accessing memory by the processing unit to ascertain and output an address information for a caller switching destination using the requested caller information;
initiating a transfer of the communication connection to the ascertained switching destination; and
requesting further information by the processing unit from the caller in a second interactive process.

16. The method as claimed in claim 15, wherein the further information request occurs after output of the address information.

17. The method as claimed in claim 15, wherein the further information is used to determine an updated switching destination by accessing the memory.

18. The method as claimed in claim 17, further comprising ascertaining and outputting an updated address information for the updated switching destination.

19. The method as claimed in claim 18, further comprising initiating the transfer of the communication connection to the updated switching destination.
